(19) United States
(12) Patent Application Publication
(10) Pub. No.: US 2024/0088438 A1
(43) Pub. Date: Mar. 14, 2024

(54) ELECTROLYTE COMPOSITION AND LITHIUM BATTERY INCLUDING THE SAME

(71) Applicant: ELECTRONICS AND TELECOMMUNICATIONS RESEARCH INSTITUTE, Daejeon (KR)

(72) Inventors: Jimin OH, Daejeon (KR); Kwang Man KIM, Daejeon (KR)

(21) Appl. No.: 18/231,849

(22) Filed: Aug. 9, 2023

(30) Foreign Application Priority Data
Aug. 24, 2022 (KR) 10-2022-0106266
Nov. 14, 2022 (KR) 10-2022-0151477

(51) Int. Cl. H01M 10/0567; H01M 4/38; H01M 4/505; H01M 4/525; H01M 10/052; H01M 10/0568; H01M 10/0569; H01M 10/42; H01M 50/417

(52) U.S. Cl. CPC H01M 10/0567; H01M 4/382; H01M 4/505; H01M 4/525; H01M 10/052; H01M 10/0568; H01M 10/0569; H01M 10/4235; H01M 50/417; H01M 2004/028

(57) ABSTRACT

An electrolyte composition of the inventive concept may include a solvent, an electrolyte salt, a first additive, and a second additive. The first additive may include at least one among a phosphor (P) compound, a nitrogen (N) compound, a sulfur (S) compound, and a lithium (Li) compound, or combinations thereof, and the second additive may include at least one among a carbonate compound, a sulfur (S) compound, and a lithium (Li) compound, or combinations thereof.

### CROSS-REFERENCE TO RELATED APPLICATIONS

This U.S. non-provisional patent application claims priority under 35 U.S.C. § 119 of Korean Patent Application Nos. 10-2022-0106266, filed on Aug. 24, 2022, and 10-2022-0151477, filed on Nov. 14, 2022, the entire contents of which are hereby incorporated by reference.

### BACKGROUND

### 1. Technical Field

The present disclosure herein relates to an electrolyte composition and a lithium battery including the same and more particularly, to an electrolyte composition including an additive.

### 2. Description of Related Art

Secondary batteries may include lithium batteries. Recently, the applicability of lithium batteries is expanded. For example, lithium batteries are widely used as power sources of electric vehicles (EV) and energy storage systems (ESS). However, flame retardant additives are not used in commercial lithium batteries until now. Accordingly, side reactions at the interface layer of the electrodes of a lithium battery are not suppressed, and there are problems of inducing marked reduction of the cycle characteristics of lithium batteries.

### SUMMARY

A technical task for solving in the present disclosure is to provide an electrolyte composition having improved flame retardant properties and stable electrochemical properties, and a lithium battery electrolyte including the same.

Another task for solving in the present disclosure is to provide a lithium battery having improved electrochemical properties.

The tasks to be solved by the inventive concept is not limited to the above-described tasks, however other tasks not mentioned will be precisely understood from the description below by a person skilled in the art.

An electrolyte composition according to embodiments of the inventive concept for solving the above-described technical tasks may include a solvent, an electrolyte salt, a first additive, and a second additive. The first additive may include at least one among a phosphor (P) compound, a nitrogen (N) compound, a sulfur (S) compound, and a lithium (Li) compound, or combinations thereof, and the second additive may include at least one among a carbonate compound, a sulfur (S) compound, and a lithium (Li) compound, or combinations thereof.

In an embodiment, the first additive may be included in about 0.5 wt % to about 30 wt % based on the electrolyte composition.

In an embodiment, the second additive may be included in about 0.5 wt % to about 30 wt % based on the electrolyte composition.

In an embodiment, the first additive may include at least one among trimethyl phosphate, triethyl phosphate, dimethyl methylphosphonate, tris(2,2,2-trifluoroethyl) phosphate, triphenyl phosphate, tris (4-methoxyphenyl) phosphine, triphenyl phosphite, tris(2,2,2-trifluoroethyl) phosphite, hexamethylphosphoramide, 4-isopropylphenyl diphenyl phosphate, hexamethoxycyclotriphosphazene, fluorocyclophosphazene, trifluoro(ethoxy)pentafluorocyclotriphosphazene, dimethyl methylphosphonate, lithium bis(oxalate borate), diethyl allylphosphoramidate, and propane-2,2-diylbis(4,1-phenylene) difluorosulfate, or combinations thereof.

In an embodiment, the second additive may include at least one among fluoroethylene carbonate, vinylene carbonate, vinyl ethylene carbonate, 1,3-propane sultone, LiPO₂F₂, LiNO₃, and LiBF₄, or combinations thereof.

In an embodiment, the first additive and the second additive may include different materials from each other.

In an embodiment, the electrolyte salt may include at least one among LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, and LiC₄BOs, or combinations thereof.

In an embodiment, a concentration of the electrolyte salt may be about 1 M to about 3 M.

In an embodiment, the solvent may include an organic solvent, and the organic solvent may include at least one among g-butyrolactone, ethylene carbonate, propylene carbonate, glycerin carbonate, dimethyl carbonate, diethyl carbonate, ethyl methyl carbonate, dimethoxyethane, and dimethyl ethylene carbonate, or combinations thereof.

A lithium battery according to embodiments of the inventive concept for solving the above-described technical tasks may include a positive electrode, a negative electrode separated from the positive electrode, and an electrolyte in contact with the positive electrode and the negative electrode. The electrolyte may include a solvent, an electrolyte salt, a first additive, and a second additive. The first additive and the second additive may include different materials from each other, and the first additive and the second additive may be respectively included in about 0.5 wt % to about 30 wt % based on the electrolyte.

In an embodiment, the first additive may include at least one among a phosphor (P) compound, a nitrogen (N) compound, a sulfur (S) compound, and a lithium (Li) compound, or combinations thereof.

In an embodiment, the first additive may include at least one among trimethyl phosphate, triethyl phosphate, dimethyl methylphosphonate, tris(2,2,2-trifluoroethyl) phosphate, triphenyl phosphate, tris (4-methoxyphenyl) phosphine, triphenyl phosphite, tris(2,2,2-trifluoroethyl) phosphite, hexamethylphosphoramide, 4-isopropylphenyl diphenyl phosphate, hexamethoxycyclotriphosphazene, fluorocyclophosphazene, trifluoro(ethoxy)pentafluorocyclotriphosphazene, dimethyl methylphosphonate, lithium bis(oxalate borate), diethyl allylphosphoramidate, and propane-2,2-diylbis(4,1-phenylene) difluorosulfate, or combinations thereof.

In an embodiment, the second additive may include at least one among a carbonate compound, a sulfur (S) compound, and a lithium (Li) compound, or combinations thereof.

In an embodiment, the second additive may include at least one among fluoroethylene carbonate, vinylene carbonate, vinyl ethylene carbonate, 1,3-propane sultone, LiPO₂F₂, LiNO₃, and LiBF₄, or combinations thereof.

In an embodiment, the positive electrode may include at least one among sulfur (S), LiCoO₂, LiNiO₂, LiNiₓCo_{y}Mn_{z}O₂ (x+y+z=1), LiMn₂O₄, and LiFePO₄, or combinations thereof.

In an embodiment, the negative electrode may include at least one among natural graphite, artificial graphite, silicon, silicon oxide and a lithium metal, or combinations thereof.

In an embodiment, the electrolyte salt may include at least one among LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, and LiC₄BOs, or combinations thereof.

In an embodiment, the solvent may include an organic solvent, and the organic solvent may include at least one among g-butyrolactone, ethylene carbonate, propylene carbonate, glycerin carbonate, dimethyl carbonate, diethyl carbonate, ethyl methyl carbonate, dimethoxyethane, and dimethyl ethylene carbonate, or combinations thereof.

In an embodiment, the lithium battery may further include a separator between the positive electrode and the negative electrode, and the electrolyte may be provided between the positive electrode and the separator, and between the negative electrode and the separator.

In an embodiment, the separator may include at least one among polyolefin and cellulose.

### BRIEF DESCRIPTION OF THE FIGURES

The accompanying drawings are included to provide a further understanding of the inventive concept and are incorporated in and constitute a part of this specification. The drawings illustrate embodiments of the inventive concept and, together with the description, serve to explain principles of the inventive concept. In the drawings:

FIG. 1 is a cross-sectional view of a lithium battery according to embodiments of the inventive concept;

FIG. 2 is an enlarged diagram of region A in FIG. 1;

FIG. 3 illustrates measured images on the self-extinguish time of Comparative Examples 1 to 5 and Examples 1 to 3;

FIG. 4A is a graph showing the self-extinguish time of Comparative Examples 1 to 4;

FIG. 4B is a graph showing the self-extinguish time of Comparative Example 5 and Examples 1 to 3; and

FIG. 5 is a graph showing capacity retention of Comparative Example 5 and Examples 1 to 3.

### DETAILED DESCRIPTION

In order to sufficiently understand the configuration and effects of the inventive concept, preferred embodiments of the inventive concept will be explained with reference to accompanying drawings. However, the inventive concept is not limited to the embodiments disclosed hereinbelow and may be accomplished by various types, and various changes may be made. The disclosure of the inventive concept may, however, be completed through the explanation on the embodiments, and the embodiments are provided to completely notify a person having ordinary skill in this technical field in which the inventive concept belongs to of the scope of the inventive concept. A person having ordinary skill in this technical field may understand where the inventive concept could be conducted under what suitable environments.

The terminology used herein is for the purpose of describing particular embodiments only and is not intended to be limiting of the invention. As used herein, the singular forms, are intended to include the plural forms as well, unless the context clearly indicates otherwise. It will be further understood that the terms “comprises” and/or “comprising”, when used in this specification, specify the presence of stated elements, steps, operations, and/or devices, but do not preclude the presence or addition of one or more other elements, steps, operations, and/or devices.

It will be understood that when a film (or layer) is referred to as being “on” another film (or layer), the film (or layer) can be directly on the other film (or layer), or intervening films (or layers) may be present.

In various embodiments described in the present disclosure, the terms first, second, third, etc. are used to describe various regions, films (or layers), etc., but these regions, films should not be limited by these terms. These terms are used only to distinguish a certain region or film (or layer) from another region or film (or layer). Accordingly, a film material referred to as a first film material in an embodiment may be termed a second film material. Each embodiment explained and illustrated herein includes a complementary embodiment. Like reference numerals refer to like elements throughout.

In the description, each of the phrases “A or B”, “at least one among A and B”, “at least one of A or B”, “A, B or C”, “at least one among A, B and C”, and “at least one of A, B or C” may include any one among the items illustrated in a corresponding phrase among the phrases, or possible all combinations thereof.

In addition, example embodiments are described herein with reference to cross-sectional views and/or plan views that are idealized example embodiments. In the drawings, the thicknesses of layers and regions may be exaggerated for effective explanation of technical contents. As such, variations from the shapes of the illustrations as a result, for example, of manufacturing techniques and/or tolerances, are to be expected. Thus, example embodiments should not be construed as limited to the particular shapes illustrated herein but are to include deviations in shapes that result, for example, from manufacturing. Thus, the regions illustrated in the drawings are schematic in nature and their shapes are not intended to illustrate the actual shape of a region of a device and are not intended to limit the scope of the present inventive concept.

The terms used in the embodiments of the inventive concept may be interpreted as commonly known meanings to a person skilled in the art unless otherwise defined differently.

Hereinafter, referring to accompanying drawings, an electrolyte composition and a lithium battery including the same according to the inventive concept will be explained.

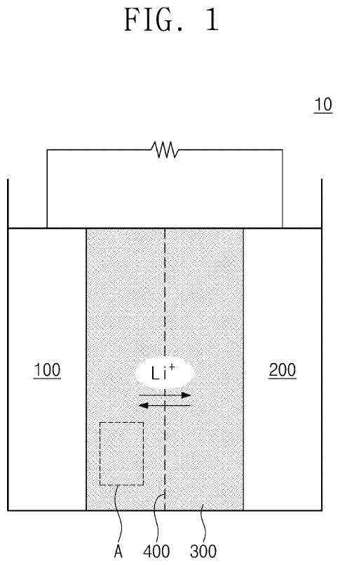

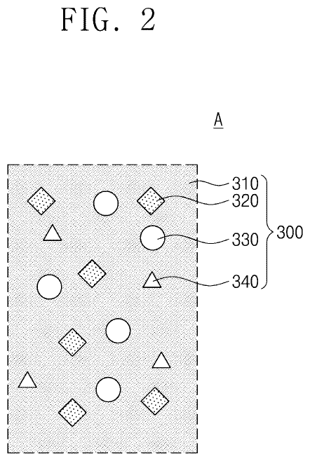

FIG. 1 is a cross-sectional view for explaining a lithium battery according to embodiments of the inventive concept. FIG. 2 is an enlarged diagram of region “A” in FIG. 1.

Referring to FIG. 1, a lithium battery 10 may include a positive electrode 100, a negative electrode 200, an electrolyte 300, and a separator 400.

The positive electrode 100 and the negative electrode 200 may be separately disposed to each other. The positive electrode 100 and the negative electrode 200 may have plate shapes facing each other. Though not shown, the space between the positive electrode 100 and the negative electrode 200 may be sealed using a separate case, or the like. The positive electrode 100 may include a positive electrode active material, a first binder and a first conductive material. The positive electrode active material may include at least one among sulfur (S), LiCoO₂, LiNiO₂, LiNiₓCo_{y}Mn_{z}O₂ (x+y+z=1, where each of x, y and z is a real number of 0 or more), LiMn—O₄, and LiFeP₄, or combinations thereof. For example, the positive electrode active material may include LiNi_{0.9}Co_{0.05}Mn_{0.05}O₂. The first binder may include an organic binder. The first binder may include a fluorine-based polymer. For example, the fluorine-based polymer may include polyvinylidene fluoride (PVdF). The first conductive material may include at least one among conductive amorphous carbon, carbon nanotube, and graphene. In the positive electrode 100, the amount ratio of the positive electrode active material:first binder:first conductive material may be about 80:10:10 to about 94:3:3. However, an embodiment of the inventive concept is not limited thereto, and the ratio of the positive electrode active material, the first binder and the first conductive material may be changed according to the properties of the positive electrode active material. The first binder and the first conductive material may improve the mechanical binding strength and electrical conductivity of the positive electrode 100.

The negative electrode 200 may include a negative electrode active material, a second binder, and a second conductive material. The negative electrode active material may include at least one among natural graphite, artificial graphite, silicon, silicon oxide and a lithium metal, or combinations thereof. The second binder may include a cellulose-based binder and/or an organic binder. The second binder may include, for example, at least one among cellulose (carboxymethyl cellulose, CMC), a styrene-butadiene rubber (SBR) emulsion, and polyvinylidene fluoride (PVdF), or combinations thereof. The weight ratio of the negative electrode active material and the second binder may be about 90:10 to about 99:1. However, an embodiment of the inventive concept is not limited thereto, and the ratio of the negative electrode active material and the second binder may be changed according to the properties of the negative electrode active material. The second conductive material may be about 0.5 wt % to about 1 wt % based on the weight of the negative electrode 200. The second conductive material may include at least one among conductive amorphous carbon, carbon nanotube, and graphene.

The separator 400 may be disposed between the positive electrode 100 and the negative electrode 200. The separator 400 may be separated from the positive electrode 100 and the negative electrode 200. The separator 400 may prevent the electrical short between the positive electrode 100 and the negative electrode 200.

The separator 400 may include a separator base material and a coating layer. The coating layer may cover the separate base material. The separator base material may include a polymer. The separator base material may include, for example, at least one among polyolefin such as polyethylene and/or polypropylene, and cellulose. The separator may include a porous polymer layer or a non-woven fabric.

The electrolyte 300 may be disposed between the positive electrode 100 and the negative electrode 200. For example, the electrolyte 300 may fill up the space between the positive electrode 100 and the separator 400, and between the negative electrode 200 and the separator 400. The electrolyte 300 may be in contact with the positive electrode 100, the negative electrode 200 and the separator 400. The electrolyte 300 may include a liquid electrolyte. The electrolyte 300 may be a non-aqueous electrolyte. That is, the electrolyte 300 may not include water. The electrolyte 300 may play the role of transferring ions to the positive electrode 100 and the negative electrode 200. For example, the ion may be a lithium (Li) ion.

The electrolyte 300 may include a solvent 310, an electrolyte salt 320, a first additive 330, and a second additive 340.

The solvent 310 may include an organic solvent. The solvent 310 may include at least one among a cyclic carbonate and a linear carbonate. The cyclic carbonate may include, for example, at least one among g-butyrolactone, ethylene carbonate, propylene carbonate, glycerin carbonate, vinylene carbonate, and fluoroethylene carbonate, or combinations thereof. The linear carbonate may include, for example, at least one among dimethyl carbonate, diethyl carbonate, ethyl methyl carbonate, dimethoxyethane, and dimethyl ethylene carbonate, or combinations thereof.

The electrolyte salt 320 may include a lithium salt. For example, the electrolyte salt 320 may include at least one among LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, and LiC₄BOs, or combinations thereof. The concentration of the electrolyte salt 320 in the electrolyte 300 may be about 1 M to about 3 M.

The first additive 330 and the second additive 340 may include different materials from each other.

The first additive 330 may include at least one among a phosphor (P) compound, a nitrogen (N) compound, a sulfur (S) compound, and a lithium (Li) compound, or combinations thereof. The first additive may include at least one among trimethyl phosphate, triethyl phosphate, dimethyl methylphosphonate, tris(2,2,2-trifluoroethyl) phosphate, triphenyl phosphate, tris (4-methoxyphenyl) phosphine, triphenyl phosphite, tris(2,2,2-trifluoroethyl) phosphite, hexamethylphosphoramide, 4-isopropylphenyl diphenyl phosphate, hexamethoxycyclotriphosphazene, fluorocyclophosphazene, trifluoro(ethoxy)pentafluorocyclotriphosphazene, dimethyl methylphosphonate, lithium bis(oxalate borate), diethyl allylphosphoramidate, and propane-2,2-diylbis(4,1-phenylene) difluorosulfate, or combinations thereof. For example, the first additive 330 may be propane-2,2-diylbis(4,1-phenylene)difluorosulfate. The first additive 330 may include a compound represented by Formula 1.

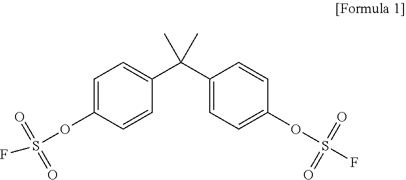 [SMILES: CC(C)(c1ccc(OS(=O)(=O)F)cc1)c1ccc(OS(=O)(=O)F)cc1]

The first additive 330 may be about 0.5 wt % to about 30 wt % based on the electrolyte 300. Particularly, the first additive 330 may be about 0.5 wt % to about 10 wt % based on the electrolyte 300.

The second additive 340 may include at least one among a carbonate compound, a sulfur (S) compound, and a lithium (Li) compound, or combinations thereof. The second additive 340 may include at least one among fluoroethylene carbonate, vinylene carbonate, vinyl ethylene carbonate, 1,3-propane sultone, LiPO₂F₂, LiNO₃, and LiBF₄, or combinations thereof. For example, the second additive 340 may be fluoroethylene carbonate. The second additive 340 may be about 0.5 wt % to about 30 wt % based on the electrolyte 300. Particularly, the second additive 340 may be about 0.5 wt % to about 10 wt % based on the electrolyte 300. For example, the total amount of the first additive 330 and the second additive 340 may be about 0.5 wt % to about 10 wt % based on the electrolyte 300.

Generally, if the positive electrode of a lithium battery includes a positive electrode active material such as nickel, cobalt and manganese (NCM), the phase change of the crystal lattice of the positive electrode active material (that is, the nickel, cobalt and manganese) may occur during discharging to a high voltage of about 4.3 V or more (for example, 4.4 V or 4.6 V). For example, a hexagonal phase in the positive electrode active material may undergo phase change into a monoclinic phase. Otherwise, different hexagonal phases included in the positive electrode active material may undergo the phase change from each other. Accordingly, oxygen may be discharged from the positive electrode active material, and the electrical capacity of the lithium battery may be reduced. In this case, the positive electrode active material may be limited to specific materials.

According to embodiments of the inventive concept, the first additive 330 may include at least one among phosphor (P), nitrogen (N), and sulfur (S). Accordingly, the lithium battery 10 may be charged to a high voltage, and the crystal lattice of the positive electrode active material may not undergo phase transition, without any restraints of the type of the positive electrode active material. Oxygen discharge may not be delayed from the positive electrode active material, and lithium deposition reaction at the surface of the negative electrode 200 may be restrained. Accordingly, the cycle characteristics and electrochemical properties of the lithium battery 10 may be improved.

In addition, the first additive 330 may be a flame retardant additive. Accordingly, the first additive 330 may provide the lithium battery 10 with flame retardant properties. That is, the first additive 330 may increase the thermal stability of the lithium battery 10.

According to embodiments of the inventive concept, the electrolyte 300 of the lithium battery 10 may include the first additive 330 and the second additive 340. The second additive 340 may be an additive for forming an interface between the electrode and the electrolyte of the lithium battery 10. Accordingly, the second additive 340 may form a coating layer at the surface of the negative electrode 200 to improve the stability between the negative electrode 200 and the electrolyte 300.

In addition, if the first additive 330 and the second additive 340 are used together, thin coating layers may be formed at the surface of the positive electrode 100 as well as the negative electrode 200. The electrochemical properties of the lithium battery 10 may be improved, and side reactions at the surfaces of the positive electrode 100 and the negative electrode 200 may be restrained by the interface between the positive electrode 100 and the negative electrode 200 and the electrolyte 300 even at a high voltage of about 4.0 V or more. Particularly, the charge and discharge efficiency and capacity retention of the lithium battery 10 may be improved. Accordingly, a lithium battery 10 having improved electrochemical properties may be provided.

In addition, in an embodiment, the first additive 330 and the second additive 340 may improve the electrochemical properties and stability of the lithium battery 10 and reduce the production cost of the lithium battery 10, only with a small amount of about 0.5 wt % to about 10 wt % based on the electrolyte 300.

### Comparative Example 1

A positive electrode was prepared as follows. Li(Ni_{0.9}Co_{0.05}Mn_{0.05})O₂ positive electrode active material:carbon black conductive material:polyvinylidene fluoride (PVdF) binder were added in a weight ratio of about 94:3:3 to a N-methyl-2-pyrrolidone (NMP) solvent to prepare a mixture. The mixture was applied onto a positive electrode current collector, and processes of drying and roll pressing were performed to form a positive electrode. In this case, an aluminum (Al) foil having a thickness of about 10 m was used as the positive electrode current collector.

A lithium (Li) foil having a thickness of about 300 m was used as a negative electrode.

Ethylene carbonate and ethyl methyl carbonate were mixed in a volume ratio of about 3:7, and a lithium salt (LiPF₆) of about 1 M was added to prepare an electrolyte.

The positive electrode, a separator and the negative electrode were laminated in order, and the electrolyte was injected to manufacture a lithium battery of Comparative Example 1. In this case, the separator used a polyethylene porous film.

Charge and discharge properties were measured as follows using the lithium battery manufactured according to Comparative Example 1. Four cycles of formation processes were performed for the lithium battery of Comparative Example 1 using a charge and discharge cycler. In the first cycle, charge and discharge were performed in a constant current mode in a speed of about 0.1 C-rate and in a range of about 3 V to about 4.3 V. The second to fourth cycles were performed in a constant current mode in a speed of about 0.2 C-rate and a constant voltage mode in a speed of about 0.02 C-rate in order and continuously. After the formation processes, the charge and discharge of the lithium battery of Comparative Example 1 were performed in a speed of about 0.3 C-rate for 50 cycles.

### Comparative Example 2

A positive electrode was prepared as follows. Li(Ni_{0.9}Co_{0.05}Mn_{0.05})O₂ positive electrode active material:carbon black conductive material:polyvinylidene fluoride (PVdF) binder were added in a weight ratio of about 94:3:3 to a N-methyl-2-pyrrolidone (NMP) solvent to prepare a mixture. The mixture was applied onto a positive electrode current collector, and processes of drying and roll pressing were performed to form a positive electrode. In this case, an aluminum (Al) foil having a thickness of about 10 m was used as the positive electrode current collector.

A lithium (Li) foil having a thickness of about 300 m was used as a negative electrode.

Ethylene carbonate and ethyl methyl carbonate were mixed in a volume ratio of about 3:7, and a lithium salt (LiPF₆) of about 1 M was added to prepare a mixture. To the mixture, about 1 wt % of fluoroethylene carbonate was added to form an electrolyte.

The positive electrode, a separator and the negative electrode were laminated in order, and the electrolyte was injected to manufacture a lithium battery of Comparative Example 2. In this case, the separator used a polyethylene porous film.

Charge and discharge properties were measured as follows using the lithium battery manufactured according to Comparative Example 2. Four cycles of formation processes were performed for the lithium battery of Comparative Example 2 using a charge and discharge cycler. In the first cycle, charge and discharge were performed in a constant current mode in a speed of about 0.1 C-rate and in a range of about 3 V to about 4.3 V. The second to fourth cycles were performed in a constant current mode in a speed of about 0.2 C-rate and a constant voltage mode in a speed of about 0.02 C-rate in order and continuously. After the formation processes, the charge and discharge of the lithium battery of Comparative Example 2 were performed in a speed of about 0.3 C-rate for 50 cycles.

### Comparative Example 3

A positive electrode was prepared as follows. Li(Ni_{0.9}Co_{0.05}Mn_{0.05})O₂ positive electrode active material:carbon black conductive material:polyvinylidene fluoride (PVdF) binder were added in a weight ratio of about 94:3:3 to a N-methyl-2-pyrrolidone (NMP) solvent to prepare a mixture. The mixture was applied onto a positive electrode current collector, and processes of drying and roll pressing were performed to form a positive electrode. In this case, an aluminum (Al) foil having a thickness of about 10 m was used as the positive electrode current collector.

A lithium (Li) foil having a thickness of about 300 m was used as a negative electrode.

Ethylene carbonate and ethyl methyl carbonate were mixed in a volume ratio of about 3:7, and a lithium salt (LiPF₆) of about 1 M was added to prepare a mixture. To the mixture, about 3 wt % of fluoroethylene carbonate was added to form an electrolyte.

The positive electrode, a separator and the negative electrode were laminated in order, and the electrolyte was injected to manufacture a lithium battery of Comparative Example 3. In this case, the separator used a polyethylene porous film.

Charge and discharge properties were measured as follows using the lithium battery manufactured according to Comparative Example 3. Four cycles of formation processes were performed for the lithium battery of Comparative Example 3 using a charge and a discharge cycler. In the first cycle, charge and discharge were performed in a constant current mode in a speed of about 0.1 C-rate and in a range of about 3 V to about 4.3 V. The second to fourth cycles were performed in a constant current mode in a speed of about 0.2 C-rate and a constant voltage mode in a speed of about 0.02 C-rate in order and continuously. After the formation processes, the charge and discharge of the lithium battery of Comparative Example 3 were performed in a speed of about 0.3 C-rate for 50 cycles.

### Comparative Example 4

A positive electrode was prepared as follows. Li(Ni_{0.9}Co_{0.05}Mn_{0.05})O₂ positive electrode active material:carbon black conductive material:polyvinylidene fluoride (PVdF) binder were added in a weight ratio of about 94:3:3 to a N-methyl-2-pyrrolidone (NMP) solvent to prepare a mixture. The mixture was applied onto a positive electrode current collector, and processes of drying and roll pressing were performed to form a positive electrode. In this case, an aluminum (Al) foil having a thickness of about 10 m was used as the positive electrode current collector.

A lithium (Li) foil having a thickness of about 300 m was used as a negative electrode.

Ethylene carbonate and ethyl methyl carbonate were mixed in a volume ratio of about 3:7, and a lithium salt (LiPF₆) of about 1 M was added to prepare a mixture. To the mixture, about 5 wt % of fluoroethylene carbonate was added to form an electrolyte.

The positive electrode, a separator and the negative electrode were laminated in order, and the electrolyte was injected to manufacture a lithium battery of Comparative Example 4. In this case, the separator used a polyethylene porous film.

Charge and discharge properties were measured as follows using the lithium battery manufactured according to Comparative Example 4. Four cycles of formation processes were performed for the lithium battery of Comparative Example 4 using a charge and a discharge cycler. In the first cycle, charge and discharge were performed in a constant current mode in a speed of about 0.1 C-rate and in a range of about 3 V to about 4.3 V. The second to fourth cycles were performed in a constant current mode in a speed of about 0.2 C-rate and a constant voltage mode in a speed of about 0.02 C-rate in order and continuously. After the formation processes, the charge and discharge of the lithium battery of Comparative Example 4 were performed in a speed of about 0.3 C-rate for 50 cycles.

### Comparative Example 5

A positive electrode was prepared as follows. Li(Ni_{0.9}Co_{0.05}Mn_{0.05})O₂ positive electrode active material:carbon black conductive material:polyvinylidene fluoride (PVdF) binder were added in a weight ratio of about 94:3:3 to a N-methyl-2-pyrrolidone (NMP) solvent to prepare a mixture. The mixture was applied onto a positive electrode current collector, and processes of drying and roll pressing were performed to form a positive electrode. In this case, an aluminum (Al) foil having a thickness of about 10 m was used as the positive electrode current collector.

A lithium (Li) foil having a thickness of about 300 m was used as a negative electrode.

Ethylene carbonate and ethyl methyl carbonate were mixed in a volume ratio of about 3:7, and a lithium salt (LiPF₆) of about 1 M was added to prepare a mixture. To the mixture, about 5 wt % of propane-2,2-diylbis(4,1-phenylene) difluorosulfate was added to form an electrolyte.

The positive electrode, a separator and the negative electrode were laminated in order, and the electrolyte was injected to manufacture a lithium battery of Comparative Example 5. In this case, the separator used a polyethylene porous film.

Charge and discharge properties were measured as follows using the lithium battery manufactured according to Comparative Example 5. Four cycles of formation processes were performed for the lithium battery of Comparative Example 5 using a charge and a discharge cycler. In the first cycle, charge and discharge were performed in a constant current mode in a speed of about 0.1 C-rate and in a range of about 3 V to about 4.3 V. The second to fourth cycles were performed in a constant current mode in a speed of about 0.2 C-rate and a constant voltage mode in a speed of about 0.02 C-rate in order and continuously. After the formation processes, the charge and discharge of the lithium battery of Comparative Example 5 were performed in a speed of about 0.3 C-rate for 50 cycles.

### Example 1

A positive electrode was prepared as follows. Li(Ni_{0.9}Co_{0.05}Mn_{0.05})O₂ positive electrode active material:carbon black conductive material:polyvinylidene fluoride (PVdF) binder were added in a weight ratio of about 94:3:3 to a N-methyl-2-pyrrolidone (NMP) solvent to prepare a mixture. The mixture was applied onto a positive electrode current collector, and processes of drying and roll pressing were performed to form a positive electrode. In this case, an aluminum (Al) foil having a thickness of about 10 m was used as the positive electrode current collector.

A lithium (Li) foil having a thickness of about 300 m was used as a negative electrode.

Ethylene carbonate and ethyl methyl carbonate were mixed in a volume ratio of about 3:7, and a lithium salt (LiPF₆) of about 1 M was added to prepare a mixture. To the mixture, about 1 wt % of fluoroethylene carbonate and about 5 wt % of propane-2,2-diylbis(4,1-phenylene) difluorosulfate were added to form an electrolyte.

The positive electrode, a separator and the negative electrode were laminated in order, and the electrolyte was injected to manufacture a lithium battery of Example 1. In this case, the separator used a polyethylene porous film.

Charge and discharge properties were measured as follows using the lithium battery manufactured according to Example 1. Four cycles of formation processes were performed for the lithium battery of Example 1 using a charge and a discharge cycler. In the first cycle, charge and discharge were performed in a constant current mode in a speed of about 0.1 C-rate and in a range of about 3 V to about 4.3 V. The second to fourth cycles were performed in a constant current mode in a speed of about 0.2 C-rate and a constant voltage mode in a speed of about 0.02 C-rate in order and continuously. After the formation processes, the charge and discharge of the lithium battery of Example 1 were performed in a speed of about 0.3 C-rate for 50 cycles.

### Example 2

A positive electrode was prepared as follows. Li(Ni_{0.9}Co_{0.05}Mn_{0.05})O₂ positive electrode active material:carbon black conductive material:polyvinylidene fluoride (PVdF) binder were added in a weight ratio of about 94:3:3 to a N-methyl-2-pyrrolidone (NMP) solvent to prepare a mixture. The mixture was applied onto a positive electrode current collector, and processes of drying and roll pressing were performed to form a positive electrode. In this case, an aluminum (Al) foil having a thickness of about 10 m was used as the positive electrode current collector.

A lithium (Li) foil having a thickness of about 300 m was used as a negative electrode.

Ethylene carbonate and ethyl methyl carbonate were mixed in a volume ratio of about 3:7, and a lithium salt (LiPF₆) of about 1 M was added to prepare a mixture. To the mixture, about 3 wt % of fluoroethylene carbonate and about 5 wt % of propane-2,2-diylbis(4,1-phenylene) difluorosulfate were added to form an electrolyte.

The positive electrode, a separator and the negative electrode were laminated in order, and the electrolyte was injected to manufacture a lithium battery of Example 2. In this case, the separator used a polyethylene porous film.

Charge and discharge properties were measured as follows using the lithium battery manufactured according to Example 2. Four cycles of formation processes were performed for the lithium battery of Example 2 using a charge and discharge cycler. In the first cycle, charge and discharge were performed in a constant current mode in a speed of about 0.1 C-rate and in a range of about 3 V to about 4.3 V. The second to fourth cycles were performed in a constant current mode in a speed of about 0.2 C-rate and a constant voltage mode in a speed of about 0.02 C-rate in order and continuously. After the formation processes, the charge and discharge of the lithium battery of Example 2 were performed in a speed of about 0.3 C-rate for 50 cycles.

### Example 3

A positive electrode was prepared as follows. Li(Ni_{0.9}Co_{0.05}Mn_{0.05})O₂ positive electrode active material:carbon black conductive material:polyvinylidene fluoride (PVdF) binder were added in a weight ratio of about 94:3:3 to a N-methyl-2-pyrrolidone (NMP) solvent to prepare a mixture. The mixture was applied onto a positive electrode current collector, and processes of drying and roll pressing were performed to form a positive electrode. In this case, an aluminum (Al) foil having a thickness of about 10 m was used as the positive electrode current collector.

A lithium (Li) foil having a thickness of about 300 m was used as a negative electrode.

Ethylene carbonate and ethyl methyl carbonate were mixed in a volume ratio of about 3:7, and a lithium salt (LiPF₆) of about 1 M was added to prepare a mixture. To the mixture, about 5 wt % of fluoroethylene carbonate and about 5 wt % of propane-2,2-diylbis(4,1-phenylene) difluorosulfate were added to form an electrolyte.

The positive electrode, a separator and the negative electrode were laminated in order, and the electrolyte was injected to manufacture a lithium battery of Example 3. In this case, the separator used a polyethylene porous film.

Charge and discharge properties were measured as follows using the lithium battery manufactured according to Example 3. Four cycles of formation processes were performed for the lithium battery of Example 3 using a charge and discharge cycler. In the first cycle, charge and discharge were performed in a constant current mode in a speed of about 0.1 C-rate and in a range of about 3 V to about 4.3 V. The second to fourth cycles were performed in a constant current mode in a speed of about 0.2 C-rate and a constant voltage mode in a speed of about 0.02 C-rate in order and continuously. After the formation processes, the charge and discharge of the lithium battery of Example 3 were performed in a speed of about 0.3 C-rate for 50 cycles.

### EXPERIMENTAL EXAMPLES

Self-Extinguish Time (SET) Measurement

The masses of a separator and an electrolyte were measured, respectively. After immersing the separator in the electrolyte for about 1 minute to about 6 hours, the electrolyte was lit. The time taken for extinguishing light, and the sum of the masses of the separator and electrolyte remaining after extinguishing light were measured. From these, the mass change of the electrolyte was calculated. The time taken for extinguishing light against the mass change of the electrolyte was calculated to obtain self-extinguish time. In this case, a polyethylene porous film was used as the separator, and each of the electrolytes of Comparative Examples 1 to Comparative Example 5, and the electrolytes of Example 1 to Example 3 was used as the electrolyte. The measurement on the self-extinguish time was repeated three times for each of the electrolytes, and the average and dispersion thereof were calculated.

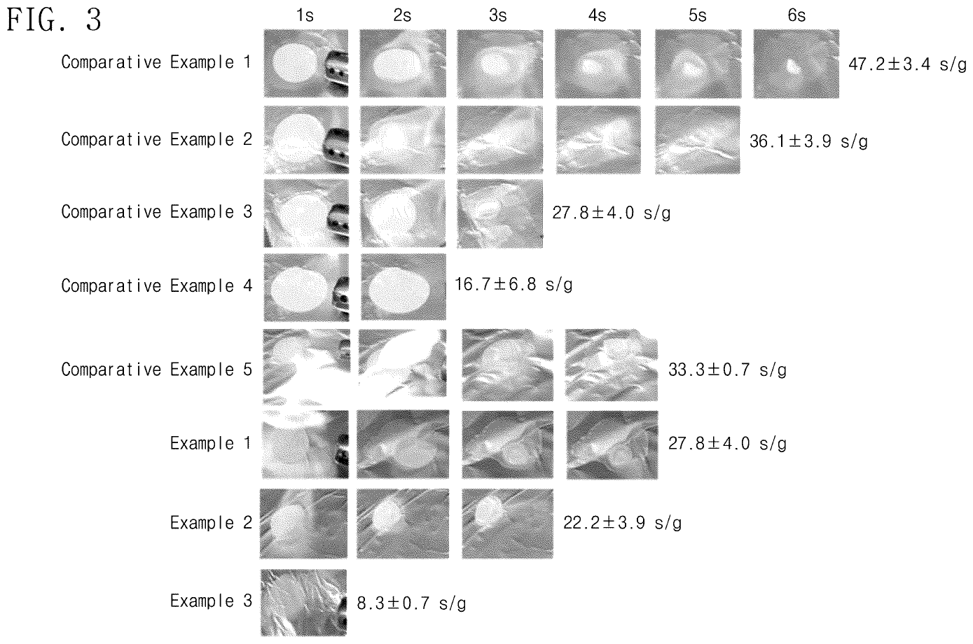

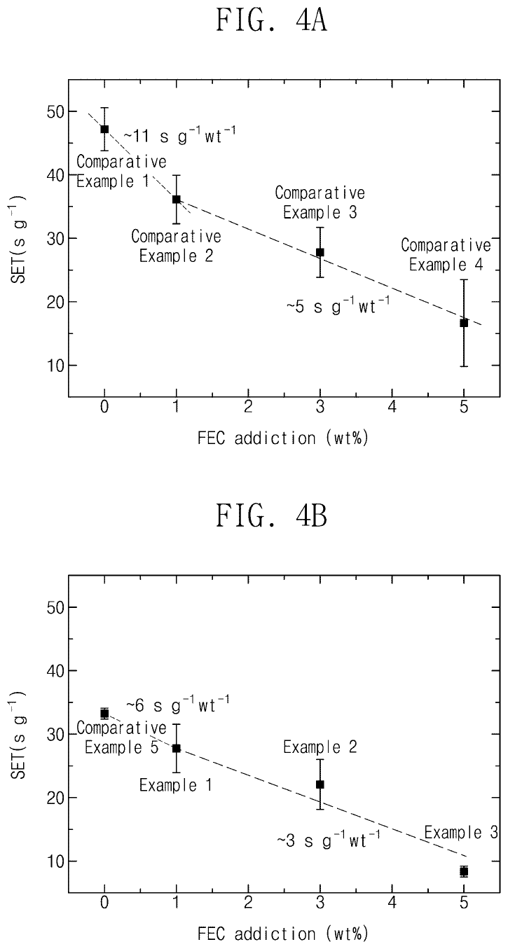

FIG. 3 illustrates measured images on the self-extinguish time of Comparative Examples 1 to 5 and Examples 1 to 3. FIG. 4A and FIG. 4B are graphs showing the self-extinguish time of Comparative Examples 1 to 5 and Examples 1 to 3.

Referring to FIG. 3, FIG. 4A and FIG. 4B, it can be confirmed that the self-extinguish time of Example 3 was about 8.3±0.7 s/g and the shortest. This means that Example 3 showed improved flame retardant properties than Comparative Example 1 in which an electrolyte additive was not included, and Comparative Examples 2 to 5 in which only one type of an electrolyte additive was included.

In addition, through Examples 1 to 3, in which two or more electrolyte additives were included, it can be confirmed that flame retardant properties were changed according to the amount of the additives in the electrolyte, and Example 3 showed the most improved flame retardant properties. That is, it can be found that the flame retardant properties can be improved according to the types of the electrolyte additives and the ratio therebetween.

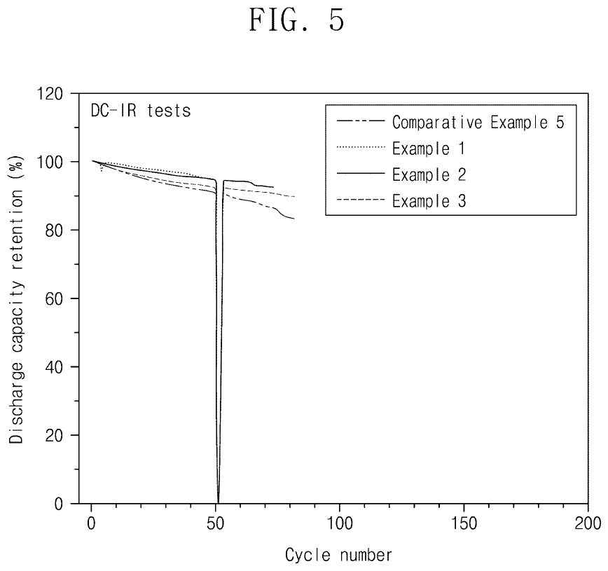

FIG. 5 is a graph showing results after performing cycles for the lithium batteries of Comparative Example 5 and Examples 1 to 3 under conditions of about 0.3 C at a voltage of about 3 to 4.3 V.

Referring to FIG. 5, it can be confirmed that the lithium battery of Example 3 showed about 85% or more capacity retention at about 80 cycles or more and improved electrochemical properties.

That is, according to the measurement results on the self-extinguish time and charge and discharge properties, it can be confirmed that the flame retardant properties and electrochemical properties were improved for Example 3 which includes two or more types of electrolyte additives.

According to the inventive concept, an electrolyte may include two or more types of electrolyte additives. The electrolyte including two or more types of electrolyte additives and a lithium battery including the same may have improved flame retardant properties and electrochemical properties.

Although the embodiments of the present invention have been described, it is understood that the present invention should not be limited to these embodiments, but various changes and modifications can be made by one ordinary skilled in the art within the spirit and scope of the present invention as hereinafter claimed.

What is claimed is:

1. An electrolyte composition comprising:
a solvent;
an electrolyte salt;
a first additive; and
a second additive,
wherein the first additive comprises at least one among a phosphor (P) compound, a nitrogen (N) compound, a sulfur (S) compound, and a lithium (Li) compound, or combinations thereof, and
the second additive comprises at least one among a carbonate compound, a sulfur (S) compound, and a lithium (Li) compound, or combinations thereof.

2. The electrolyte composition of claim 1, wherein the first additive is comprised in about 0.5 wt % to about 30 wt % based on the electrolyte composition.

3. The electrolyte composition of claim 1, wherein the second additive is comprised in about 0.5 wt % to about 30 wt % based on the electrolyte composition.

4. The electrolyte composition of claim 1, wherein the first additive comprises at least one among trimethyl phosphate, triethyl phosphate, dimethyl methylphosphonate, tris(2,2,2-trifluoroethyl) phosphate, triphenyl phosphate, tris (4-methoxyphenyl) phosphine, triphenyl phosphite, tris(2,2,2-trifluoroethyl) phosphite, hexamethylphosphoramide, 4-isopropylphenyl diphenyl phosphate, hexamethoxycyclotriphosphazene, fluorocyclophosphazene, trifluoro(ethoxy)pentafluorocyclotriphosphazene, dimethyl methylphosphonate, lithium bis(oxalate borate), diethyl allylphosphoramidate, and propane-2,2-diylbis(4,1-phenylene) difluorosulfate, or combinations thereof.

5. The electrolyte composition of claim 1, wherein the second additive comprises at least one among fluoroethylene carbonate, vinylene carbonate, vinyl ethylene carbonate, 1,3-propane sultone, LiPO₂F₂, LiNO₃, and LiBF₄, or combinations thereof.

6. The electrolyte composition of claim 1, wherein the first additive and the second additive comprise different materials from each other.

7. The electrolyte composition of claim 1, wherein the electrolyte salt comprises at least one among LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, and LiC₄BOs, or combinations thereof.

8. The electrolyte composition of claim 1, wherein a concentration of the electrolyte salt is about 1 M to about 3 M.

9. The electrolyte composition of claim 1, wherein the solvent comprises an organic solvent, and
the organic solvent comprises at least one among g-butyrolactone, ethylene carbonate, propylene carbonate, glycerin carbonate, dimethyl carbonate, diethyl carbonate, ethyl methyl carbonate, dimethoxyethane, and dimethyl ethylene carbonate, or combinations thereof.

10. A lithium battery comprising:
a positive electrode;
a negative electrode separated from the positive electrode; and
an electrolyte in contact with the positive electrode and the negative electrode, wherein
the electrolyte comprises:
a solvent;
an electrolyte salt;
a first additive; and
a second additive,
the first additive and the second additive comprise different materials from each other, and
the first additive and the second additive are respectively comprised in about 0.5 wt % to about 30 wt % based on the electrolyte.

11. The lithium battery of claim 10, wherein the first additive comprises at least one among a phosphor (P) compound, a nitrogen (N) compound, a sulfur (S) compound, and a lithium (Li) compound, or combinations thereof.

12. The lithium battery of claim 10, wherein the first additive comprises at least one among trimethyl phosphate, triethyl phosphate, dimethyl methylphosphonate, tris(2,2,2-trifluoroethyl) phosphate, triphenyl phosphate, tris (4-methoxyphenyl) phosphine, triphenyl phosphite, tris(2,2,2-trifluoroethyl) phosphite, hexamethylphosphoramide, 4-isopropylphenyl diphenyl phosphate, hexamethoxycyclotriphosphazene, fluorocyclophosphazene, trifluoro(ethoxy)pentafluorocyclotriphosphazene, dimethyl methylphosphonate, lithium bis(oxalate borate), diethyl allylphosphoramidate, and propane-2,2-diylbis(4,1-phenylene) difluorosulfate, or combinations thereof.

13. The lithium battery of claim 10, wherein the second additive comprises at least one among a carbonate compound, a sulfur (S) compound, and a lithium (Li) compound, or combinations thereof.

14. The lithium battery of claim 10, wherein the second additive comprises at least one among fluoroethylene carbonate, vinylene carbonate, vinyl ethylene carbonate, 1,3-propane sultone, LiPO₂F₂, LiNO₃, and LiBF₄, or combinations thereof.

15. The lithium battery of claim 10, wherein the positive electrode comprises at least one among sulfur (S), LiCoO₂, LiNiO₂, LiNiₓCo_{y}Mn_{z}O₂ (x+y+z=1), LiMn₂O₄, and LiFePO₄, or combinations thereof.

16. The lithium battery of claim 10, wherein the negative electrode comprises at least one among natural graphite, artificial graphite, silicon, silicon oxide and a lithium metal, or combinations thereof.

17. The lithium battery of claim 10, wherein the electrolyte salt comprises at least one among LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, and LiC₄BOs, or combinations thereof.

18. The lithium battery of claim 10, wherein the solvent comprises an organic solvent, and
the organic solvent comprises at least one among g-butyrolactone, ethylene carbonate, propylene carbonate, glycerin carbonate, dimethyl carbonate, diethyl carbonate, ethyl methyl carbonate, dimethoxyethane, and dimethyl ethylene carbonate, or combinations thereof.

19. The lithium battery of claim 10, further comprising a separator between the positive electrode and the negative electrode, and
the electrolyte being provided between the positive electrode and the separator, and between the negative electrode and the separator.

20. The lithium battery of claim 19, wherein the separator comprises at least one among polyolefin and cellulose.
